(19) United States
(12) Patent Application Publication
(10) Pub. No.: US 2003/0149739 A1
(43) Pub. Date: Aug. 7, 2003

(54) Method for retrieving, organizing and utilizing on-line poster abstracts

(76) Inventors: Doug Adams, Narberth, PA (US); Tom Dugdale, Bryn Mawr, PA (US); Harinder Singh, Marlton, NJ (US); Gregory Szczyrbak, Lancaster, PA (US)

Correspondence Address: Licata & Tyrrell P.C., 66 E. Main Street, Marlton, NJ, 08053, US

(21) Appl. No.: 09/998,100

(22) Filed: Nov. 30, 2001

Related U.S. Application Data
(60) Provisional application No. 60/250,030, filed on Nov. 30, 2000.

(51) Int. Cl. G06F 15/16

(52) U.S. Cl. 709/217

(57) ABSTRACT

A method for archiving, indexing and disseminating poster abstracts is provided.

### INTRODUCTION

This application claims the benefit of priority from U.S. provisional application Serial No. 60/250,030, filed Nov. 30, 2000.

### FIELD OF THE INVENTION

The invention relates to a system, method and medium for retrieving, organizing and utilizing on-line poster abstracts.

### BACKGROUND

Poster sessions are currently conducted by thousands of participants at hundreds of universities and professional scholarly societies for a wide range of disciplines including science, social science and the humanities. Some universities house their poster abstracts on line. However these are typically not well organized or indexed. Currently, there is no universal collection of poster abstracts stored and archived in a central database. Databases that include pre-publication material such as poster abstracts would be a valuable source to begin tracking early stage research. Businesses, especially those engaged in research and development, are becoming increasingly interested in identifying and tracking early stage research and development. There is, however, no organized process for doing this. Utilizing the Internet World Wide Web, the present invention provides a method for creating and accessing a universal collection of poster abstracts.

A systematic method and viable medium is desired if early stage research and development is to be identified. In a disk-based environment, computer users are limited to the confines of their own personal computer and content aggregators prearrange how content is displayed and accessed. Most content aggregators do not consider arranging and displaying content for the purpose of trend analysis. Because of this method and medium, a disk-based environment does not scale well for large amounts of information, thereby infringing the ability of the computer user to identify trends throughout a multi-disciplinary environment.

The Internet World Wide Web (WWW) provides a rich medium due to the fact that links are constructed between related information. By utilizing links and citations, many different web pages can be pulled together for purposes of retrieval. Because of the vastness and no controlling authority of the WWW, it cannot be browsed exhaustively. The computer user desires relevant retrieval of sought content. Universities, professional scholarly societies and businesses would benefit from a systematically indexed set of poster abstracts. This online index would act as an early warning system to identify patenting opportunities and technology commercialization. This index would supplement what is already known about a given published author. In addition, this index would provide a means for establishing contact with the author(s). The present invention provides a method for archiving, indexing, accessing and disseminating information about poster abstracts. The value of this knowledge is that it is an early warning system of trends that is pre-publication and pre-patent.

### SUMMARY OF THE INVENTION

The present invention provides a method for archiving, indexing and disseminating poster abstracts by creating a record for each poster abstract, indexing the record so that the researcher and the nature of the research are easily identifiable, storing the records on a server and providing a means for accessing the server so that a subscriber can access the information.

### DESCRIPTION OF THE INVENTION

The present invention which is referred to as “Poster-Link” offers a method of organizing and sharing information among universities students and faculty, professional and scholarly society members and businesses; and offers benefits to all users. The invention utilizes the World Wide Web or “Web”. As is well known to those of skill in the art, the Web refers to both a distributed collection of interlinked, user viewable hypertext documents, commonly referred to as Web documents or Web pages, that are accessible via the Internet and client and server software components which provide user access to such documents using standardized Internet protocols. Currently, the primary standard protocol for allowing applications to locate and acquire Web documents is HTTP and Web pages are encoded using HTML. As is known to those of skill in the art, in a distributed system, a program at one site sends a request to a program at another site and waits for a response. The requesting program is referred to as the “client” and the program which responds is called the “server”. In the context of the Web, the client is a Web browser, which runs on the computer of the user and the program server. In the present invention, Poster-Link maintains a Web site, which is a computer system that serves informational content over a network using the standard protocols of the World Wide Web and corresponds to the Internet domain name Poster-Link and includes poster abstracts and information about researchers. As used herein, the term is intended to cover both the hardware/software server component that serve the information content over the network and back end hardware and software components that interact with the server components to perform services for Web Site users, such as generating reports.

Poster-Link provides a graphical browser interface that is user friendly for the end user regardless of operating system. The system's database will permit storage of and access to abstracts indexed by: author, contact, organization, department, address, sponsor(s), topic classification, keyword(s) presentation date and abstract. Monitoring abstracts will permit several forms of knowledge creation. Reports of research conducted by members of universities and professional scholarly societies can be generated. Opportunities for cross-disciplinary opportunities for research and licensing can also be identified.

For researchers, the recognizable abstract format will enhance their poster presentations, provide the ability to share their research through abstracts and oral presentations, allow identification of patentable subject matter and initiate intellectual property protection by means of appropriate technology transfer offices, introduce available expertise and resources to companies and the wider research community. Poster-Link allows for the rapid dissemination of information throughout the research community for sharing knowledge and for monitoring competitors.

By monitoring university and professional society research via Poster-Link, an early opportunity to identify commercial potential is afforded entrepreneurs and venture capitalists. Through participation in Poster-Link, area businesses can identify research expertise to develop research collaborations and to identify qualified employment candidates.

In the present invention, authors submit poster abstracts to Poster-Link along with their e-mail address. Poster-Link uploads the abstracts onto its Web page. The submission form allows the researcher to choose terms from a general thesaurus. The researcher may also suggest additional terms to describe and categorize their research for proper indexing. A confirmation e-mail is returned to the research acknowledging receipt of the abstract and submission information. An abstract review committee at Poster-Link retrieves the abstracts from the Poster-Link database. Abstracts are indexed and classified by an information specialist. Abstracts are then resubmitted to the Poster-Link database for inclusion in the Web site.

Poster-Link will license access of its Web database to the universities, professional and scholarly societies, fellow researchers, entrepreneurs, venture capitalists and companies. Poster-Link can also provide reports from its database for subscribers including researchers, businesses, venture capitalists and entrepreneurs. Organizations can download their portion of Poster-Link's database in order to print abstract booklets to be used for poster sessions. Poster-Link can also provide copies of the abstracts to appropriate technology transfer offices in a format suitable for promoting the technology, soliciting licensees and identifying intellectual property issues.

What is claimed is:

1. A method for archiving, indexing and disseminating poster abstracts comprising:
creating a record for a poster abstract;
indexing and classifying the record so that researcher and nature of the research are easily identifiable;
storing the record on a server; and
providing a means for accessing the server so that a subscriber can access the record.
